(19) United States
(12) Patent Application Publication
(10) Pub. No.: US 2003/0048898 A1
(43) Pub. Date: Mar. 13, 2003

(54) Method of encrypting the data transmission in a data processing unit, particularly a smart card

(76) Inventor: Frank Boeh, Rosengarten (DE)

Correspondence Address: U.S. Philips Corporation, 580 White Plains Road, Tarrytown, NY, 10591, US

(21) Appl. No.: 10/173,347

(22) Filed: Jun. 17, 2002

(30) Foreign Application Priority Data
Jun. 20, 2001 (DE) 10129643.6

(51) Int. Cl. H04L 9/00

(52) U.S. Cl. 380/30

(57) ABSTRACT

The invention relates to a method of encrypting the data transmission in a data processing unit such as particularly a smart card. While optimally utilizing the working memory, the method elucidated hereinbefore allows computation of the multiplicative inverse value u⁻¹(mod v) of an integer u modulo v which is required for performing an RSA algorithm. A Euclidic algorithm for computing the greatest common divisor of u and v is performed with two variables a, b, which are initialized with u and v. In parallel, values ax, ay, bx, by are computed in each iteration step, which values always comply with the equations

a=u·ax−v·ay

−b=u·bx−v·by

At the end of the algorithm the searched multiplicative inverse value is:

u⁻¹(mod v)=−bx.

The invention relates to a method of computing the modular inverse values u⁻¹ (mod v) and v⁻¹ (mod u) of two predetermined positive integers u and v for the implementation of a cryptographic method in data processing systems with a small working memory. The invention also relates to a method of encrypting the data transmission in a data processing unit, particularly a smart card, by means of the RSA algorithm, and to a data processing unit, particularly a smart card, for performing said method.

With the increasing use of electronic data processing in all ways of life, the protection of the processed data from abuse becomes increasingly important. This particularly also applies to data processing units in the form of smart cards on which these often security-critical data such as credit accounts, personal data, health data and the like are stored.

Asymmetrical cryptographic methods which work with a private key and a public key are particularly suitable for encrypting the data transmission. A widely used method is the RSA algorithm by Rivest, Shamir and Adleman of 1977 (cf. Rechenberg, Pomberger: Informatik-Handbuch, 2nd Edition, Hanser Verlag Munich, Vienna (1999) chapter 3.4). In this method, a subscriber selects two large prime numbers p and q for generating a pair of keys and computes therefrom the modulus n=p·q as well as the value Φ =(p−1)·(q−1). Furthermore, he selects a random number e<n, which cannot be divided by Φ and computes the d<n with d·e mod(Φ)=1. The public key is then the pair (e, n) and the private key is d.

A message m<n to be encrypted, represented as a number m, can now be modulo-n raised to a higher power by its transmitter with the aid of the public key e of the receiver so as to generate the encrypted message c: c=m^{e} mod(n). The receiver can generate the clear text again: m=cd mod(n) by exponentiating the cipher text c with his private key.

The security of the RSA algorithm is based on the difficulty of dividing the modulus n in the two prime numbers p and q which are only known to the owner of the private key. This difficulty increases with the length of the prime factors p and q for which lengths of between 512 and 1024 bits are currently used.

The processing of such long prime factors presents a problem, particularly for data processing systems with limited working memories. For this reason, the RSA algorithm for smart cards is currently typically limited to a key length of 512 to about 700 bits.

It is an object of the invention to provide a method and a data processing unit with which a secure encryption of the data transmission is possible, also when only a small working memory is available.

This object is achieved by means of a method defined in claims 1, 2 and 4 and a data processing unit defined in claim 5. Advantageous embodiments are defined in the dependent claims.

The invention relates to a method of computing the modular inverse values u⁻¹(mod v) and v⁻¹(mod u) of two predetermined positive integers u and v. The inverse value of an integer u modulo of another integer v is, if it exists, defined as that number x :=u⁻¹(mod v) for which it holds that: u x(mod v)=1. In the implementation of an RSA algorithm, the computation of the modular inverse value is required to compute the private key d from the random number e. Based on the value of the integers u, v involved, which correspond to the prime factors p and q, this method requires a considerable working memory capacity. In data processing systems with small working memories, this requirement is finally the limiting factor for the value of the key which can be used in the RSA algorithm. The method is characterized by the following steps:

a) definition of the values

a₀:=u,

b₀:=v,

ax₀:=1,

ay₀:=0,

bx₀:=0,

by₀:=1.

b) successive computation for k 0; 1; 2; 3; . . . to kmax of

b1) if aₖ<bₖ: aₖ₊₁:=aₖ

bₖ₊₁:=bₖ−aₖ

axₖ₊₁:=axₖ

ayₖ₊₁:=ayₖ

bxₖ₊₁:=bxₖ+axₖ

byₖ₊₁:=byₖ+ayₖ

b2) if aₖ≧bₖ: aₖ₊₁:=aₖ−bₖ

bₖ₊₁:=bₖ

axₖ₊₁:=axₖ+bxₖ

ayₖ₊₁:=ayₖ+byₖ

bxₖ₊₁:=bxₖ

byₖ₊₁:=byₖ

wherein the computation of the sequences at which the index kmax is ended is akmax=0

c) if bₖₘₐₓ=1, compute the searched modular inverse values to

u⁻¹(mod v)=−bxₖₘₐₓ

v⁻¹(mod u)=byₖₘₐₓ

As compared with the method hitherto known (described, for example, by Bruce Schneier, “Applied Cryptography”, 2nd Edition 1996, page 247), the above-mentioned method has the advantage that it requires a considerably reduced working memory capacity. This is caused by the fact that the memory locations required for the variables aₖ and bₖ decrease on average to the same extent as the required memory location for the variables axₖ, ayₖ, bxₖ and byₖ increases because in each iteration step b) the mutually opposite operations of addition and subtraction are performed on the two different types of variables. In the method, the values aₖ and bₖ are manipulated in accordance with the known Euclidic algorithm for computing the greatest common divisor of u and v. The residual values are manipulated in such a way that the following equations always apply:

aₖ=u·axₖ−v·ayₖ

−bₖ=u·bxₖ−v·byₖ

The invention further relates to a second method of computing the modular inverse values u⁻¹(mod v) and v⁻¹(mod u) of two predetermined positive integers u and v for the implementation of a cryptographic method in data processing systems with a small working memory. The method is distinguished from the above-mentioned method in that at least one of the two numbers u and/or v is odd. It is characterized by the following steps:

a) definition of the values

a₀:=u,

b₀:=v,

ax₀:=1,

ay₀:=0,

bx₀:=0,

by₀:=1,

z₀:=0.

b) successive computation for k=0; 1; 2; 3; . . . to kmax of:

αₖ with: aₖ=2^{αk} a′ₖ and a′k is odd

βₖ with: bₖ=2^{βk} b′ₖ and b′ₖ is odd

zₖ₊₁:=zₖ+αₖ+βk

and

b1) if a′k≧b′ₖ: aₖ

bₖ₊₁:=b′k−a′ₖ

axₖ₊₁:=2^{βk}axₖ

ayₖ₊₁:=2^{βk}ayₖ

bxₖ₊₁:=2^{αk}bxₖ°2^{βk}axₖ

byₖ₊₁:=2^{αk}byₖ+2^{βk}ayₖ

b2) if a′ₖ≧b′ₖ: aₖ₊₁:=a′ₖ−b′ₖ

bₖ₊₁:=b′ₖ

axₖ₊₁:=2^{βk}axₖ+2^{αk}bxₖ

ayₖ₊₁:=2^{βk} ayₖ+2^{αk}byₖ

bxₖ₊₁:=2^{αk}bxₖ

bxₖ₊₁:=2^{αk}byₖ

wherein the computation of the sequences at which the index kmax is ended is aₖ max=0

c) if bₖₘₐₓ=1, successively compute k=kmax to (kmax+zₖₘₐₓ−1):

$${bx}_{k + 1} \{ := \begin{matrix}{bx}_{k} / 2 if {bx}_{k} and {by}_{k} are even \\ ( {bx}_{k} + v ) / 2 else\end{matrix} \\ {by}_{k + 1} \{ := \begin{matrix}{by}_{k} / 2 if {bx}_{k} and {by}_{k} are even \\ ( {by}_{k} + u ) / 2 else\end{matrix}$$

d) compute the searched modular inverse values of

u⁻¹(mod v)=−bx_{kmax+zkmax}

v⁻¹(mod u)=by_{kmax+zkmax}

In addition to the first method elucidated above, this method performs an extraction of the factor 2 whenever it occurs in intermediate values. On condition that at least one of the two numbers u, v is odd, a more rapid convergence of the algorithm can thereby be achieved. Also in this algorithm, opposite operations are performed in parallel. For example, when dividing a value aₖ or bₖ by 2, the values axₖ, ayₖ, bxₖ and byₖ are multiplied in parallel by the factor 2 so that, on average, the overall memory location required for storing these variables remains approximately equal.

The methods of the type described above can be particularly performed by a data processing unit, in which the available working memory is dynamically adapted to the memory location required for the current value of the variables aₖ, bₖ , axₖ, bxₖ, ayₖ and byₖ. This renders it possible to utilize the limited working memory to an optimal extent because the part of the working memory required in a given stage of the algorithm is allocated to each variable, while a part of the values steadily requires a smaller memory location in the course of the process and the rest of the values steadily requires a larger memory location. The method may be particularly implemented in the form of a computer program run on the data processing unit. Such a program is preferably stored in non-volatile memories (ROM, EEPROM, etc.) or on memory media (hard disk, diskette, CD, etc.).

The invention further relates to a method of encrypting the data transmission in a data processing unit, particularly a smart card, by means of the RSA algorithm. The method is characterized in that a private key is computed by means of a method of the type described above. Since the methods mentioned above utilize the working memory better than current methods, the modular inverse values of comparatively large numbers, for example prime numbers having a length of 1024 bits can be computed by means of these methods. This thus allows the generation and use of correspondingly long keys in the RSA algorithm, which enhances its security accordingly.

The invention further relates to a data processing unit, particularly a smart card, which is adapted to perform a method of the type described above. Such a data processing unit thus preferably includes a non-volatile memory for storing the program code which is implemented in a method of the type described, and a working memory for storing the variables manipulated in the method.

The invention will hereinafter be elucidated by way of example with reference to program listings.

For better understanding, the first listing shows the known binary Euclidic algorithm for computing the greatest common divisor (gcd) of two numbers u, v. It is assumed that at least one of the two numbers u, v is odd, which allows the variables a and b to be possibly divided by 2 if these might meanwhile assume even values.

| 1 | % | Binary Euclidean Algorithm |
|---|---|---|
| 2 | % | Input: |
| 3 | % | u, v: positive integers with gcd(gcd(u,v),2) = 1. |
| 4 | % | Computes: |
| 5 | % | b = gcd(u,v) |
| 6 | | |
| 7 | a := u | |
| 8 | b := v | |
| 9 | | |
| 10 | while a <> O | |
| 11 | while (a mod 2) = 0 | |
| 12 | | a := a/2 |
| 13 | end | |
| 14 | | |
| 15 | while (b mod 2) = 0 | |
| 16 | | b := b/2 |
| 17 | end | |
| 18 | | |
| 19 | if a < b | |
| 20 | | b := b−a |
| 21 | else | |
| 22 | | a := a−b |
| 23 | end | |
| 24 | end | |

The next second listing shows a program for realizing the method according to the invention for computing the modular inverse values:

| 1 | % | Extended Binary Euclidean Algorithm | |
|---|---|---|---|
| 2 | % | Input: | |
| 3 | % | u,v: positive integers with gcd(gcd(u,v),2) = 1. | |
| 4 | % | | |
| 5 | % | Computes: | |
| 6 | % | −bx = rcp(u,v) = (u\hat{ }(−1))mod v | (if gcd(u,v)=1) |
| 7 | % | by = rcp(v,u) = (v\hat{ }(−1))mod u | (if gcd(u,v)=1) |
| 8 | % | b = gcd(u,v) | |
| 9 | % | | |

| 10 | % | The algorithm bases on the following set of | |
|---|---|---|---|
| 11 | % | equations, which are fulfilled at each program | |
| 12 | % | step below that is marked with (*): | |
| 13 | % | a*(2\hat{ }exp) = u*ax − v*ay | |
| 14 | % | −b*(2\hat{ }exp) = u*bx − v*by | |
| 15 | | | |
| 16 | a := u | | |
| 17 | b := v | | |
| 18 | ax := 1 | | |
| 19 | ay := O | | |
| 20 | bx := O | | |
| 21 | by := 1 | | |
| 22 | exp := O | | |
| 23 | | | |
| 24 | | | |
| 25 | while a <> 0 | | |
| 26 | (*) | | |
| 27 | | | |
| 28 | while (a mod 2) = 0 | | |
| 29 | | exp := exp+1 | |
| 30 | | a := a/2 | % a is even at this point ! |
| 31 | | bx := bx*2 | |
| 32 | | by := by*2 | |
| 33 | (*) | | |
| 34 | end | | |
| 35 | | | |
| 36 | | | |
| 37 | while (b mod 2) = 0 | | |
| 38 | | exp := exp+1 | |
| 39 | | b := b/2 | % b is even at this point ! |
| 40 | | ax := ax*2 | |
| 41 | | ay := ay*2 | |
| 42 | (*) | | |
| 43 | end | | |
| 44 | | | |
| 45 | | | |
| 46 | if a < b | | |
| 47 | | b := b−a | |
| 48 | | bx := bx+ax | |
| 49 | | by := by+ay | |
| 50 | else | | |
| 51 | | a := a−b | |
| 52 | | ax := ax+bx | |
| 53 | | ay := ay+by | |
| 54 | end | | |
| 55 | (*) | | |
| 56 | | | |
| 57 | end | | |
| 58 | | | |

| 59 | % | Intermediate results at this point: |
|---|---|---|
| 60 | % | a = 0 |
| 61 | % | b = gcd(u,v) |
| 62 | | |
| 63 | | |
| 64 | while exp > 0 | |
| 65 | exp := exp−1 | |
| 66 | | |
| 67 | if ((bx mod 2) <> O) or ((by mod 2) <> 0) | |
| 68 | | bx := bx+v |
| 69 | | by := by+u |
| 70 | end | |
| 71 | | |

| | | |
|---|---|---|
| 72 | bx := bx/2 | % bx is even at this point ! |
| 73 | by := by/2 | % by is even at this point ! |
| 74 | (*) | |
| 75 | | |
| 76 | end | |

In the second listing, the binary Euclidic algorithm represented above is extended by the computation of the modular or also multiplicative inverse values.

This “Extended Binary Euclidic Algorithm” requires six further run variables a, b, ax, ay, bx, by stored in the working memory, in addition to two values u, v (which may be stored in the EEPROM). For the sake of simplicity it is assumed that a and b are of the same order or word length L. All of the six run variables are principally present in the same order as u, v, with which in a first set-up the required working memory location would be 6*L (similarly as in existing implementations).

The invention is applied here and reduces the required memory location to 4*L due to a changed course of the algorithm. In the initialization phase for the run variables (lines 16 to 21) the variables a, b are applied in their full word length of L, while for ax, ay, bx, by only 1 bit is required. The initially required working memory capacity thereby results in L*2+4 bits.

During the iteration loop (lines 25 to 57), complementary operations are exclusively performed with the groups a, b and ax, ay, bx, by. When group a, b is divided by 2, the group ax, ay, bx, by is simultaneously multiplied by 2 (lines 29-32 and 38-41, respectively). When a subtraction with a, b is performed, an addition with ax, ay, bx, by is performed simultaneously (lines 47-49 and 51-53, respectively). As a result, the required length of the run variables a, b decreases to an equal extent on average as the required length of the variables ax, ay, bx, by increases. The overall required working memory capacity thereby increases continuously.

After the end of the iteration loop, the result is a=0 and b=gcd(u,v). For the interesting cases, the result is b=1. If gdc (u, v)>1, there is usually no multiplicative inverse value. The required working memory capacity is L*4+2 bits at this instant.

The run variables ax, ay are no longer used subsequently. In the next loop, in which the lengths of the working variables bx, by do not change, the required working memory location is thus L*2 bits.

Considering the overall algorithm, the required working memory capacity is thus always smaller than or equal to L*4+2 bits. To provide the possibility of “growth” or “shrinkage” of the run variables in the memory, an intelligent memory management is necessary, which continuously tests the relevant variables for imminent overflows (ax, ay, bx, by) or tests zeroes (a, b) and possibly performs a re-organization by way of shifts in the working memory.

While optimally utilizing the working memory, the method elucidated hereinbefore thus allows computation of the multiplicative inverse value u⁻¹ (mod v) of an integer u modulo v which is required for performing an RSA algorithm. A Euclidic algorithm for computing the greatest common divisor of u and v is performed with two variables a, b, which are initialized with u and v. In parallel, values ax, ay, bx, by are computed in each iteration step, which values always comply with the equations

a=u·ax−v·ay

−b=u·bx−v·by

At the end of the algorithm the searched multiplicative inverse value is:

u⁻¹(mod v)=−bx.

1. A method of computing the modular inverse values u⁻¹ (mod v) and v⁻¹ (mod u) of two predetermined positive integers u and v for the implementation of a cryptographic method in data processing systems with a small work memory, the method comprising the steps of:
a) definition of the values
a₀:=u,
b₀:=v,
ax₀:=1,
ay₀:=0,
bx₀:=0,
by₀:=1,
b) successive computation for k=0; 1; 2; 3; . . . to kmax of:
b1) if a′k<bₖ: aₖ₊₁:=aₖ
bₖ₊₁:=bₖ−aₖ
axₖ₊₁:=axₖ
ayₖ₊₁:=ayₖ
bxₖ₊₁:=bxₖ+axₖ
byₖ₊₁:=byₖ+ayₖ
b2) if aₖ≧bₖ: aₖ₊₁:=aₖ−bₖ
bₖ₊₁:=bₖ
axₖ₊₁:=axₖ+bxₖ
ayₖ₊₁:=ayₖ+byₖ
bxₖ₊₁:=bxₖ
byₖ₊₁:=byₖ
wherein the computation of the sequences at which the index kmax is ended is aₖₘₐₓ=0
c) if bₖₘₐₓ=1, compute the searched modular inverse values to
u⁻¹(mod v)=−bxₖₘₐₓ
v⁻¹(mod u)=byₖₘₐₓ
.

2. A method of computing the modular inverse values u⁻¹(mod v) and v⁻¹(mod u) of two predetermined positive integers u and v, in which u and/or v is odd, for the implementation of a cryptographic method in data processing systems with a small working memory, the method comprising the steps of:
a) definition of the values
a₀:=u,
b₀:=v,
ax₀:=1,
ay₀:=0,
bx₀:=0,
by₀:=1,
z₀:=0.
b) successive computation for k=0; 1; 2; 3; . . . to kmax of:
αₖ with: aₖ=2^{αk} a′ₖ and a′k is odd
βₖ with: bₖ=2^{βk} b′ₖ and b′ₖ is odd
zₖ₊₁:=zₖ+αₖ+βk
and
b1) if a′k≧b′ₖ: aₖ
bₖ₊₁:=b′k−a′ₖ
axₖ₊₁:=2^{βk}axₖ
ayₖ₊₁:=2^{βk}ayₖ
bxₖ₊₁:=2^{αk}bxₖ°2^{βk}axₖ
byₖ₊₁:=2^{αk}byₖ+2^{βk}ayₖ
b2) if a′ₖ≧b′ₖ: aₖ₊₁:=a′ₖ−b′ₖ
bₖ₊₁:=b′ₖ
axₖ₊₁:=2^{βk}axₖ+2^{αk}bxₖ
ayₖ₊₁:=2^{βk} ayₖ+2^{αk}byₖ
bxₖ₊₁:=2^{αk}bxₖ
bxₖ₊₁:=2^{αk}byₖ
wherein the computation of the sequences at which the index kmax is ended is aₖₘₐₓ=0
c) if bₖₘₐₓ=1, successively compute k=kmax to (kmax+xₖₘₐₓ−1):
bxₖ₊₁{:=bxₖ/2 if bxₖ and byₖ are even (bxₖ+v)/2 else
byₖ₊₁{:=byₖ/2 if bxₖ and byₖ are even (byₖ+u)/2 else
d) compute the searched modular inverse values of
u⁻¹(mod v)=−bx_{kmax+zkmax}
v⁻¹(mod u)=by_{kmax+zkmax.}

3. A method as claimed in claim 1 or 2, characterized in that the method is performed by a data processing unit in which the division of the available working memory is dynamically adapted to the required memory location of the variables (aₖ, bₖ , axₖ, bxₖ, ayₖ, byₖ).

4. A method of encrypting the data transmission in a data processing unit, particularly a smart card, by means of the RSA algorithm, characterized in that a private key is computed by means of a method as claimed in any one of claims 1 to 3.

5. A data processing unit, particularly a smart card, characterized in that it is adapted to perform a method as claimed in any one of claims 1 to 4.
